(19) United States
(12) Patent Application Publication
(10) Pub. No.: US 2006/0183518 A1
(43) Pub. Date: Aug. 17, 2006

(54) System for securing a cellular phone and viewing information window

(76) Inventor: Bernard Emano, Fort Lauderdale, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 11/059,890

(22) Filed: Feb. 17, 2005

(51) Int. Cl. H04M 1/00

(52) U.S. Cl. 455/575.8

(57) ABSTRACT

A system or case for the folding of a cellular phone having an associated viewing window includes a semi-rigid substantially rectangular case for effecting the selectable securement of a cellular phone therein, the case having a front major base and a rear major base having an opening substantially proportioned in size and shape to the viewing window and keypad of the cellular phone when the phone is fully secured within the case. The rear major base includes front top and bottom edges. The inventive system further includes a pressure actuated closure means (PACM) secured within the rear major base and to the left and right of the opening. The system also includes a substantially rectangular rigid back panel having a lower edge and an upper edge, the lower edge secured to the bottom edge of the rear major base of the semi-rigid case by binary pivot means having selectable positions of either zero and about 90 degrees relative to the rigid back panel. The system also includes a second PACM secured within the back panel at locations substantially congruent with the PACM of the rear major base of the semi-rigid case when the rear major base is pivoted into a closure positioned against the rigid back panel. The system yet further includes a belt clip for selectable manual securement to a belt of the user.

### BACKGROUND OF THE INVENTION

A. Area of Invention

The present invention relates to means for holding cellular telephones and viewing information appearing upon the display window thereof.

B. Prior Art

Cellular phones have been known for many years as have cases having clips associated therewith for the securement thereof upon a belt of a user or a strap of a lady's handbag. Such cases, while useful for their intended purpose of holding the cell phone in close proximity to its user, can occasionally create inconvenience when a phone call is received that the user of such a system does not wish to take at that time or not at all, for example where the name of the caller is blocked or unknown. Where, in prior art systems, this were to occur, the user of the case would suffer the inconvenience of removing the cell phone from his case to look at the viewing window thereof and, thereafter, returning the cell phone to the case and effecting the closure thereof.

The instant invention addresses this problem through the provision of a case for the securement of a cell phone on or near the person of the user, without need to open such case to ascertain the identity (or lack thereof) associated with a given phone call.

### SUMMARY OF THE INVENTION

The present invention relates to a system or case for the folding of a cellular phone having a viewing window associated therewith. The system includes a semi-rigid substantially rectangular case for effecting the selectable securement of a cellular phone therein, said case having a front major base and a rear major base having therein an opening substantially proportioned in size and shape to said viewing window and keypad of the cellular phone when said phone is fully secured within said case. Said rear major base includes front top and bottom edges. The inventive system further includes a pressure actuated closure means (PACM) secured within said rear major base and to the left and right of said opening therein. The system further includes a substantially rectangular rigid back panel having a lower edge and an upper edge, said lower edge secured to said bottom edge of said rear major base of said semi-rigid case by binary pivot means having selectable positions of either zero and about 90 degrees relative to said rigid back panel. The system also includes a second PACM secured within said back panel at locations substantially congruent with said PACM of said rear major base of said semi-rigid case when said rear major base is pivoted into a closure positioned against said rigid back panel. The system yet further includes a belt or strap clip for selectable manual securement to a belt or handbag strap of a system user, said clip having an outer planar surface thereof secured said rigid back panel.

It is accordingly an object of the invention to provide a system for the securement of a cellular phone to enable observation of the viewing window thereof without requirement for removal of the phone from a case secured to the person of a user thereof.

It is another object to provide a case for the holding of a cellular telephone to permit the viewing of information provided by the phone relative to the identity of incoming phone calls so that the user can make a decision regarding whether or not to remove the phone from its case for purposes of “taking” the call, based on direct observation of the viewing window of the phone before it has been removed from the case.

It is a further object of the invention to provide a system of the above type having similar utility for use with straps of ladies handbags, purses, and related personal articles.

It is a further object to provide a system of the above type that may be secured upon or within an attaché case or the like to permit the user thereof to view incoming calls without removal of the phone from the case associated thereof.

Of the above and yet other objects and advantages of the present invention have become apparent from herein set forth brief description of the Drawings, Detailed Description of the Invention, and Claims as pended herewith.

### BRIEF DESCRIPTION OF THE DRAWINGS

FIG. 1 is a perspective view showing the cellular phone carrying case attached to the belt of a user prior to placement of a phone therein.

FIG. 2 is a view, sequential to that of FIG. 1, showing the opening of the case and the viewing window thereof within the rear major base of the case.

FIG. 3 is a view, sequential to that of FIG. 2, showing placement of a cellular phone into a cell phone case.

FIG. 4 is a perspective view, sequential of that is FIG. 3, showing a cell phone placed within the case and fully secured therein.

FIG. 5 is a operational view of the inventive system showing the 90 degree pivot relationship between the rear major base of the phone case and the rigid rear panel of the system, by which a user of the invention may observe relevant incoming information regarding a caller without removal of the phone from the case. FIG. 5 also shows an embodiment of the invention in which the keypad of the phone is accessible should one wish to use the same.

FIG. 6 is a rear plan view of the illustration in FIG. 5 but without showing of the belt of a user.

### DETAILED DESCRIPTION OF THE INVENTION

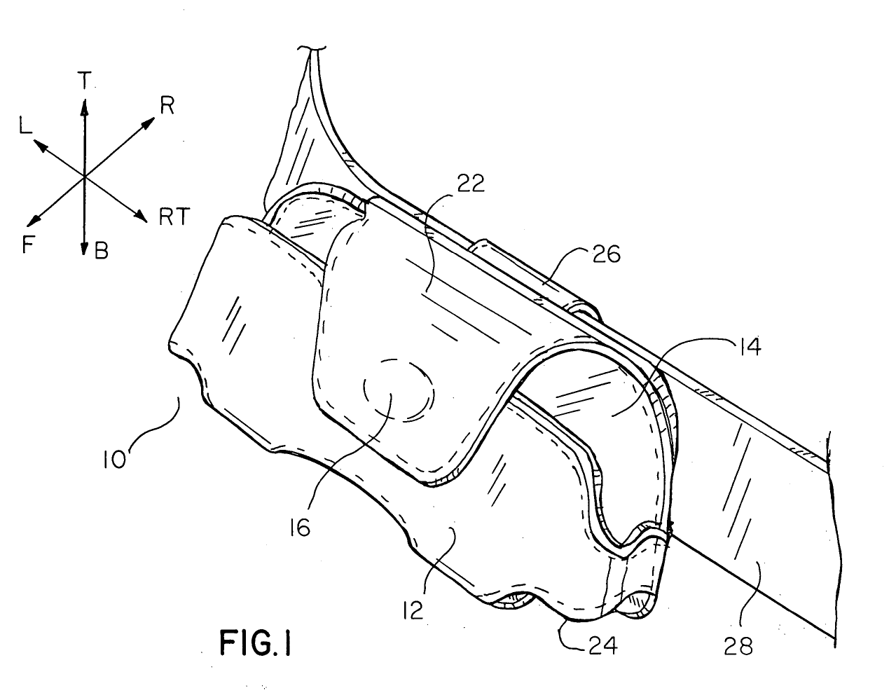

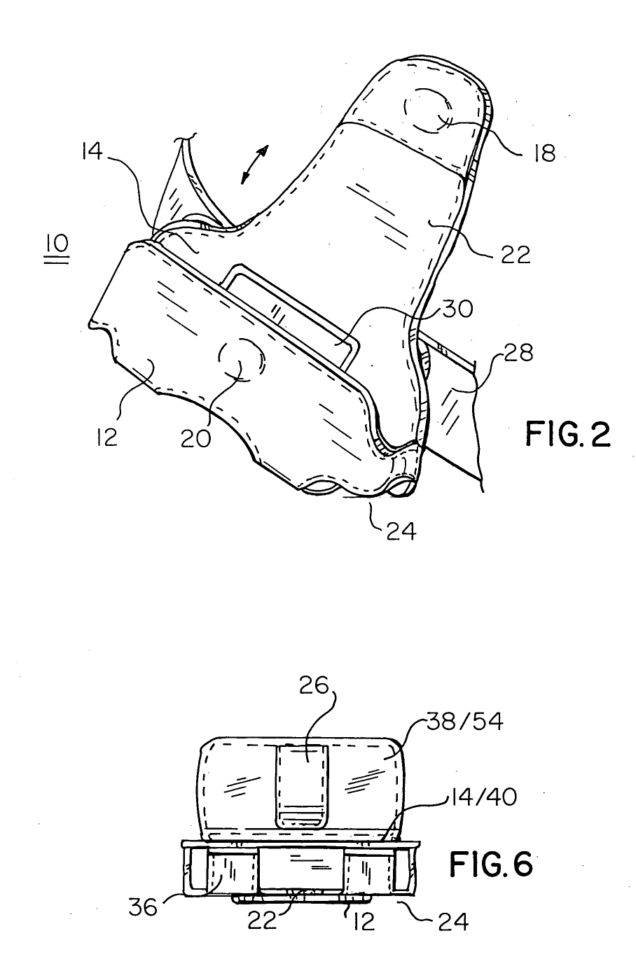

With reference to the perspective view of FIG. 1, the invention may be appreciated with reference to a Cartesian axis which appears at the upper left thereof. Such axis includes a front-rear axis (the FR axis), a left-right axis (the LRT axis) and a top-bottom axis (the TB axis). With reference to these definitions, the present inventive system for the holding of the cellular phone may, when the same is in a closed state, be seen to include a semi-rigid substantially rectangular case 10 having a front major base 12 and a rear major base 14. Further shown in FIG. 1 is a magnetic snap 16, consisting of attractive elements 18 and 20 respectively (See FIG. 2) which facilitate the selectable opening and closing of the case relative to a cell phone, as is more fully set forth below. As may be appreciated with reference to FIG. 1, the width, length and depth of case 10 is defined by said front and rear base 12 and 14 respectively, as well as by a case closure element 22. The case enables securement of a cell phone while permitting corners thereof to be seen through respective open corners 24 of the case itself.

Further shown in FIG. 1 is a belt or strap clip 26 adapted for securement to a belt or strap 28 of a user.

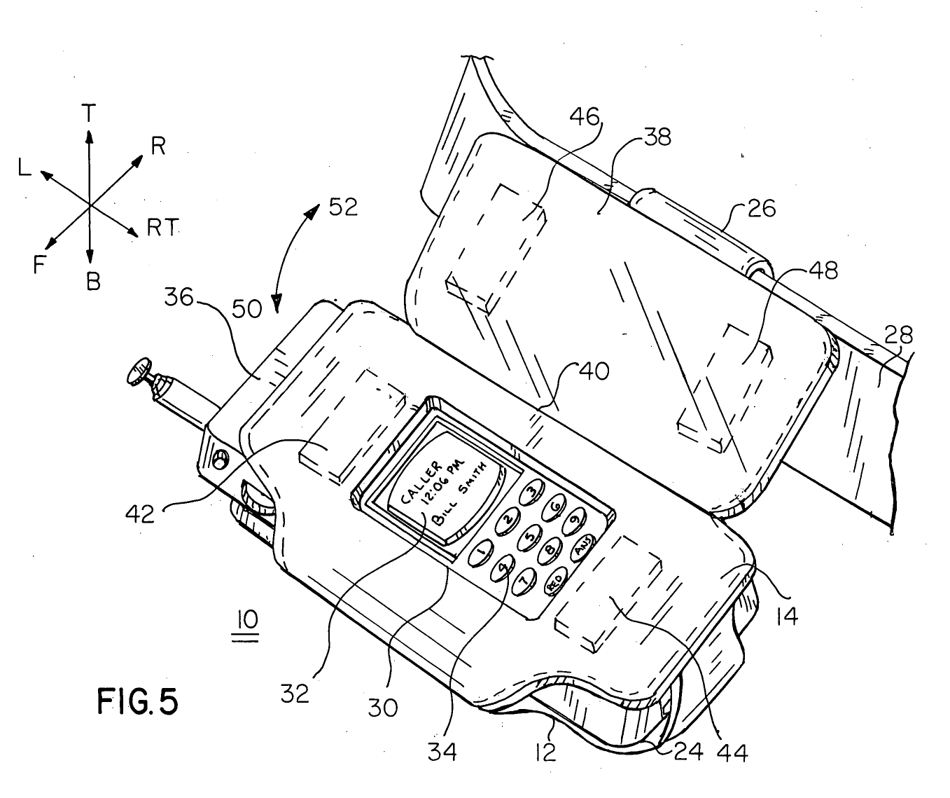

As may be noted in FIG. 2, rear major base 14 of the case 10 includes therein an opening 30 which is substantially proportioned in size and shape to at least that of a viewing window 32 of phone 36. See FIG. 5. In a preferred opening 30 of rear major base 14 is sufficient in size to permit access by a system user to both a keypad 34 and said viewing window 32.

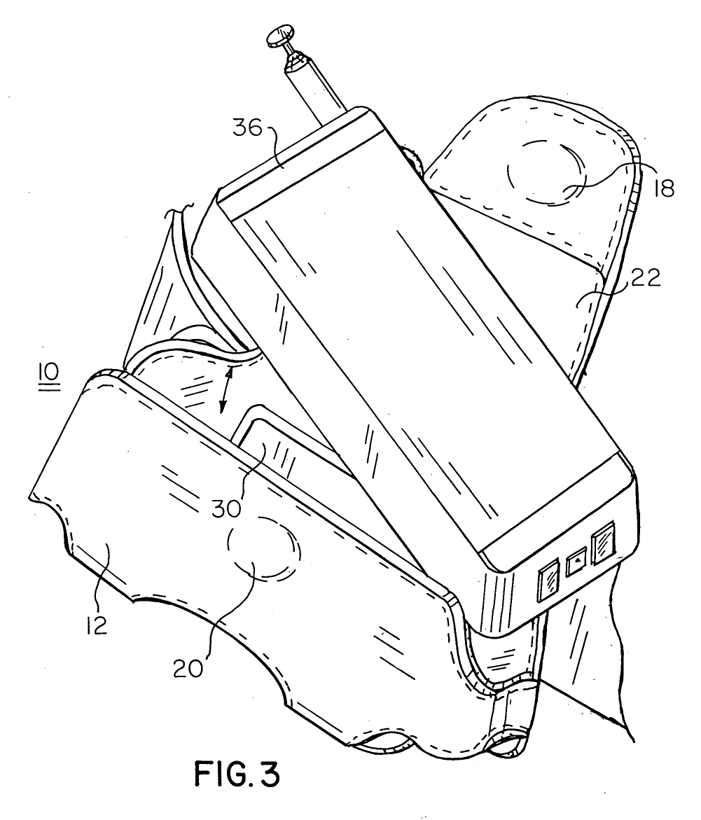

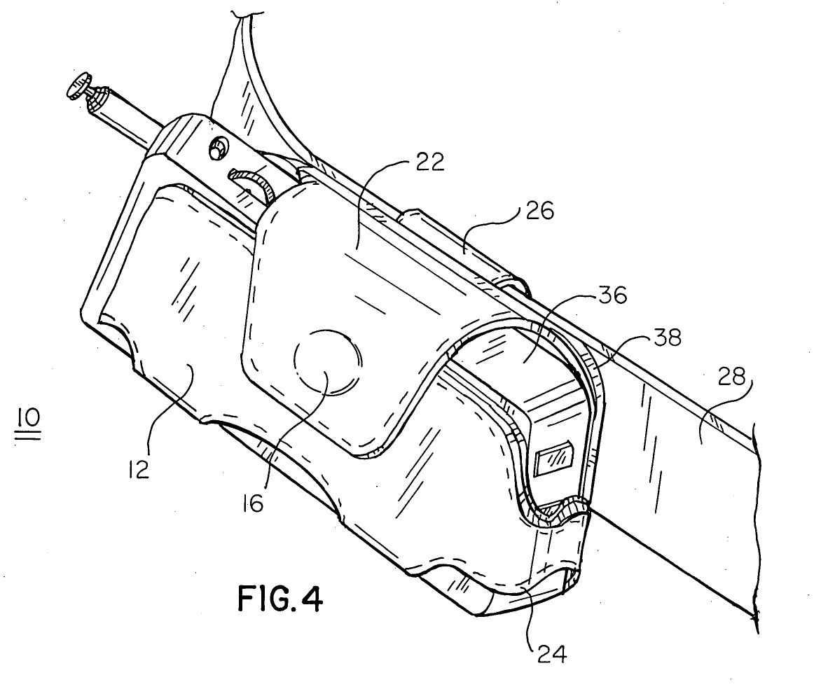

The manner of insertion of the cell phone 36 into case 10 may be seen with reference to FIG. 3. Therein the front of phone 36 is positioned against rear panel 14 of the case such that window 32 and keypad 34 are aligned with opening 30 upon the insertion thereinto of the phone. See FIG. 4.

With reference to FIG. 5 there are shown further material aspects of the present invention which, particularly, include a rigid back panel 38, in the TB-LRT plane, pivotally secured to said rear or major base 14 by binary pivot means 40, a first pair of pressure actuated closure means (PACM 42 and 44) embedded within said rear major base 14 and back panel 38, a second pair of PACM 46 and 48 embedded within said rigid back panel 38 at a position congruent with said first PACM 42/44 when case 10 is rotated upwardly by pivot means 40 against and into contact with panel 38 to thereby affect the closure of rear base 14 onto rigid back panel 38 by the attractive securement of first PACM 42/44 to second PACM 46/48. The respective PACM may take the form of pairs of magnets having an attractive polarity relative to each other or hook-and-pile means (such as Velcro) to accomplish the same purpose.

A salient feature of pivot means 40 that facilitates the essential function of the present invention is that the range of motion thereof must be approximately 90 degrees such that opening 30 and viewing window 32 can be conveniently viewed by a user when the case 30 is “flipped” down, in the FR-TB plane as is indicated by downward arrow 50, into its viewing position. That is, rotation of case 10 relative to rigid back panel 38 of substantially more or less than 90 degrees will impair the essential functionality of the invention in that the viewing window must be observable by the user. Such a 90 degree range of motion of pivot means may be readily achieved through the use of digital springs or hinges (not shown) which have a binary mechanical function, i.e., are either fully closed (as when the PACM are secured to each other) or fully open to 90 degrees as is shown in FIG. 5.

To close the case and phone relative to rear panel 38 and belt 28, said case is simple rotated upward in direction 52 such that the system can then be closed and carried upon the belt 28 in the fashion shown in FIG. 4. Thereby, upon receipt of an incoming call the user will pull 16 open and flip case 10 downward in direction 50 to view call window 32 through panel opening 30. At that time the case is located substantially parallel to the floor or ground (the FR-LRT plane) and, thereby, is readily observable by the system user. Thereupon the user can make a decision regarding whether to take the call or not. If he/she decides to take the call, the phone may be pulled out of the case either in the forward direction or in the left hand direction, while panel 38 and, thereby, the entire case 10 remains secured to belt 28 by clip 26 which, as above noted, is secured to the rear side 54 of panel 38. The relationship of the system elements, when the case is an open position relative to rear panel 38, may be more fully appreciated with reference to the rear plan view of FIG. 6.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

Having thus described our invention what we claim as new, useful and non-obvious and, accordingly, secure by Letters Patent of the United States is:

1. A system for holding a cellular phone having a viewing window and keypad, the system comprising:
(a) a semi-rigid substantially rectangular case for selectable securement of a cell phone therein, said case having a front major base and a rear major base, said rear base having therein an opening proportioned in size and shape to at least said viewing window of said cell phone when said phone is secured within said case, said rear base having a forward top edge and a bottom edge;
(b) pressure actuated closure means secured within said rear major base to the left and right of said opening;
(c) a substantially rectangular rigid back panel having a lower edge and an upper edge, said lower edge secured to said bottom edge of said rear major base of said semi-rigid case by binary pivot means having selectable positions of either zero and about 90 degrees;
(d) pressure actuated closure means secured within said back panel at locations congruent with said pressure actuated closure means of said rear major base of said case when said rear major base is pivoted into a system closure position against said rigid back panel; and
(e) a clip for selectable securement to a belt strap of a system user, said clip having an outer surface thereof secured to said back panel.

2. The system as recited in claim 1 in which said pressure actuated closure means comprises opposing pairs of attractive bar magnets.

3. The system as recited in claim 2 in which said pressure actuated closure means comprises opposing pairs of hook-and-pile means.

4. The system as recited in claim 1 in which said opening of said case is proportioned in size and shape to an aggregate dimension of said window and keypad of said phone.
